(19) United States
(12) Patent Application Publication
(10) Pub. No.: US 2017/0139470 A1
(43) Pub. Date: May 18, 2017

(54) METHOD FOR INTELLIGENTLY CONTROLLING CONTROLLED EQUIPMENT AND DEVICE

(71) Applicant: SHENZHEN SKYWORTH-RGB ELECTRONIC CO., LTD., Shenzhen, Guangdong (CN)

(72) Inventor: Weijie Wang, Shenzhen, Guangdong (CN)

(73) Assignee: SHENZHEN SKYWORTH-RGB ELECTRONIC CO., LTD., Shenzhen, Guangdong (CN)

(21) Appl. No.: 15/319,383

(22) PCT Filed: Aug. 13, 2015
(86) PCT No.: PCT/CN2015/086878

§ 371 Date: Dec. 16, 2016

(30) Foreign Application Priority Data
May 26, 2015 (CN) 201510275680.2

(51) Int. Cl. G06F 3/00; H04L 29/06; G06K 9/00

(52) U.S. Cl. CPC G06F 3/005; G06K 9/00771; G06K 9/00362; H04L 63/12; H04L 63/0861

(57) ABSTRACT

The present disclosure provides a method for intelligently controlling a controlled equipment, which includes the following steps: a current scene is monitored, when a user exists in the current scene, scene information of the current scene is acquired, and the current scene is recognized according to the scene information to acquires a scene recognizing result; action information of the user is acquired, the action information is recognized to acquires an action recognizing result; a controlled equipment matched with the scene recognizing result and the action recognizing result is controlled according to the scene recognizing result and the action recognizing result. The present disclosure further provides a device for intelligently controlling a controlled equipment. The present disclosure controls the corresponding controlled equipment through recognizing the current scene and the user's action, therefore intelligently controlling the controlled equipment is realized, user does not need to do special action or gesture.

### FIELD OF THE DISCLOSURE

The present disclosure relates to the field of intelligently controlling technologies, and in particular, to a method for intelligently controlling a controlled equipment and a device.

### BACKGROUND OF THE DISCLOSURE

With the rapid development of internet of things, methods of controlling controlled equipment through intelligent controlling system are more and more rich. Currently, one common controlling method is installing application which is used for controlling the controlled equipment on a mobile terminal, user can input controlling instruction through the application on the mobile terminal, the mobile terminal sends the controlling instruction to a controlling center, then the controlling center transforms the controlling instruction to controlling commands having different code values, and sends the transformed controlling commands to a specified controlled equipment through an emitting module, thus achieving the controlling of the controlled equipment. However, this method needs user taking the mobile terminal, and the user should input instruction on the mobile terminal, the operation is complex. In addition, currently, one much intelligent method is controlling the controlled equipment through voice recognizing, user speaks word command to a voice receiving end, the voice receiving end processes a voice recognition to the word command, and transforms into the controlling command, and sends the controlling command to a controlling center, the controlling center controls the controlled equipment according the controlling command However, the voice controlling method is prone to being affected by ambient noise, pronounce regional difference, so the voice controlling method exists a big error, and the accuracy of the controlling command is low.

### SUMMARY OF THE DISCLOSURE

The present disclosure is to provide a method for intelligently controlling a controlled equipment and a device, the intelligently controlling is easy to operate, and the accuracy of controlling instruction is high.

The present disclosure provides the method for intelligently controlling a controlled equipment, which includes the following steps:

monitoring a current scene, when a user exists in the current scene, acquiring scene information of the current scene, recognizing the current scene according to the scene information, a scene recognizing result is acquired;

acquiring action information of the user, recognizing the action information , an acquiring action recognizing result; and

controlling a controlled equipment matched with the scene recognizing result and the action recognizing result according to the scene recognizing result and the action recognizing result.

Preferably, controlling a controlled equipment matched with the scene recognizing result and the action recognizing result according to the scene recognizing result and the action recognizing result includes:

finding a matched controlling instruction and the matched controlled equipment according to the scene recognizing result and the action recognizing result;

sending the controlling instruction to the matched controlled equipment.

Preferably, before sending the controlling instruction to the matched controlled equipment, the method for intelligently controlling the controlled equipment further includes:

acquiring a current state of the matched controlled equipment;

judging whether the current state of the matched controlled equipment is consistent with a corresponding state of the controlling instruction;

when the current state is consistent with the corresponding state of the controlling instruction, making the controlling instruction to be not sent out;

when the current state is not consistent with the corresponding state of the controlling instruction, sending the controlling instruction to the matched controlled equipment.

Preferably, before acquiring action information of the user, the method for intelligently controlling the controlled equipment further includes:

acquiring identity information of the user, judging whether the user is a legitimate user;

when the user is the legitimate user, acquiring the action information of the user;

when the user is not the legitimate user, starting an alarm system.

Preferably, acquiring the identify of the user, judging whether the user is the legitimate user includes:

extracting portrait characters of the user from the scene information;

recognizing the portrait characters of the user, judging whether the portrait characters of the user are consistent with prestored portrait characters of the legitimate user;

if yes, judging the user as the legitimate user;

if not, judging the user as an illegal user.

Preferably, the scene information is a scene photo or a video taken by a camera; the action information of the user is an action video of the user taken by the camera.

The present disclosure also provides the device for intelligently controlling the controlled equipment, which includes:

a scene analyzing module, the scene analyzing module is used for monitoring a current scene, when a user exists in the current scene, and the scene analyzing module acquires scene information of the current scene, and the current scene is recognized according to the scene information, a scene recognizing result is acquired;

an action analyzing module, the action analyzing module is used for acquiring action information of the user, the action information is recognized, an action recognizing result is acquired; and

a controlling module, the controlling module is used for controlling a controlled equipment matched with the scene recognizing result and the action recognizing result according to the scene recognizing result and the action recognizing result.

Preferably, the controlling module is also used for:

finding a matched controlling instruction and the matched controlled equipment according to the scene recognizing result and the action recognizing result;

sending the controlling instruction to the matched controlled equipment.

Preferably, the device for intelligently controlling the controlled equipment further includes a state analyzing module, which is used for acquiring a current state of the matched controlled equipment; judging whether the current state of the matched controlled equipment is consistent with a corresponding state of the controlling instruction;

the controlling module does not send the controlling instruction when the current state is consistent with the corresponding state of the controlling instruction, when the current state is not consistent with the corresponding state of the controlling instruction, the controlling module is used for sending the controlling instruction to the matched controlled equipment.

Preferably, the device for intelligently controlling the controlled equipment further includes an identity recognizing module and an alarming module;

the identity recognizing module is used for acquiring identity information of the user, whether the user is a legitimate user is judged;

when the user is the legitimate user, the action analyzing module is also used for acquiring the action information of the user;

the alarming module is used for starting alarm system when the user is not the legitimate user.

Preferably, the identity recognizing module is also used for:

extracting portrait characters of the user from the scene information;

recognizing the portrait characters of the user, whether the portrait characters of the user are consistent with prestored portrait characters of the legitimate user is judged;

if yes, the user is judged as the legitimate user;

if not, the user is judged as an illegal user.

Preferably, the scene information is a scene photo or a video taken by a camera; the action information of the user is an action video of the user taken by the camera.

The present disclosure controls the corresponding controlled device through recognizing the current scene and user's action, for achieving intelligently controlling the controlled equipment, the user does not need to do special action or gesture, also does not need to take a mobile terminal used for sending instruction, it is much more intelligent and convenient to control the controlled equipment.

### BRIEF DESCRIPTION OF THE DRAWINGS

FIG. 1 is a flow diagram of a method for intelligently controlling a controlled equipment provided by a first exemplary embodiment of the present disclosure;

FIG. 2 is a flow diagram of a method for intelligently controlling a controlled equipment provided by a second exemplary embodiment of the present disclosure;

FIG. 3 is a flow diagram of a method for intelligently controlling a controlled equipment provided by a third exemplary embodiment of the present disclosure;

FIG. 4 is a flow diagram of a method for intelligently controlling a controlled equipment provided by a fourth exemplary embodiment of the present disclosure;

FIG. 5 is a flow diagram of a method for intelligently controlling a controlled equipment provided by a fifth exemplary embodiment of the present disclosure;

FIG. 6 is a module diagram of a device for intelligently controlling a controlled equipment provided by a first exemplary embodiment of the present disclosure;

FIG. 7 is a module diagram of a device for intelligently controlling a controlled equipment provided by a second exemplary embodiment of the present disclosure;

FIG. 8 is a module diagram of a device for intelligently controlling a controlled equipment provided by a third exemplary embodiment of the present disclosure.

The realizing of the aim, functional characteristics, advantages of the present disclosure are further described in detail with reference to the accompanying drawings and the embodiments.

### DETAILED DESCRIPTION OF THE EMBODIMENTS

It is to be understood that, the described embodiments are only some exemplary embodiments of the present disclosure, and the present disclosure is not limited to such embodiments.

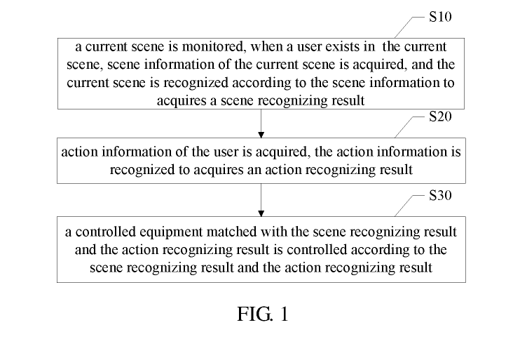

Referring to FIG. 1, FIG. 1 is a flow diagram of a method for intelligently controlling a controlled equipment provided by a first exemplary embodiment of the present disclosure. The method for intelligently controlling the controlled equipment provided by the first exemplary embodiment includes the following steps:

Step S10, monitoring a current scene, when a user exists in the current scene, acquiring scene information of the current scene, and recognizing the current scene according to the scene information, acquiring a scene recognizing result;

The exemplary embodiment is mainly used in an intelligent system, and is applied in environment, such as home, office, security, and so on, for intelligently controlling equipment, such as household equipment, office equipment, security system, and so on. Functions, such as acquiring, analyzing, recognizing, matching data, and sending instruction, can be finished by the intelligent controlling system. Taking the room environment for an example, image or video acquiring equipment (such as a camera) is installed at each scene of the room, such as a door, a sitting room, a dining room, a bedroom and so on, each scene is monitored by the camera, when the user enters into one scene, such as the user works to the sitting room, when a portrait is monitored in the current scene through the camera installed in the sitting room, the camera acquires the scene information of the current scene, such as the camera takes images of the current scene, or records videos of the current scene. The camera transmits the acquired scene information to the intelligent system, the intelligent system recognizes according to the scene information, such as image processing, visual identifying and so on, for acquiring the scene recognizing result, and the current scene is recognized as the sitting room. In addition, the recognized scene can also be a much more detail scene, such as the user works to the sitting room and go to a sofa nearby, and the acquired scene recognizing result can be “sitting room +sofa.

Step S20, acquiring action information of the user, recognizing the action information, an acquiring action recognizing result;

The scene information of the current scene is acquired, simultaneously the camera also shoots user's action video, which can be used as the action information of the user. The camera transmits user's action information to the intelligent controlling system, the intelligent controlling system recognizes user's action information through the technologies of image processing, visual recognizing, mode recognizing and so on, for acquiring user's detail action, such as, the user sits down the sofa in the sitting room, and the action recognizing result “sitting down” is acquired.

Step S30, controlling the controlled equipment matched with the scene recognizing result and the action recognizing result according to the scene recognizing result and the action recognizing result.

The intelligent controlling system associates the information of the current scene with information of the controlled equipment installed or placed in the scene, and stores the associated information of the current scene and the information of the controlled equipment in advance, that is, what controlled equipment are installed or placed in the current scene, so that the corresponding controlled equipment can be found out and be intelligently controlled after the current scene is recognized. Such as the sitting room has a suspended ceiling, a television A, a cabinet air conditioner, and so on, the bedroom has a table lamp, a television B, a hanging type air conditioner, and so on. After acquiring the scene recognizing result and the action recognizing result, the intelligent controlling system can directly send the recognizing results to the matched controlled equipment, as the controlled equipment generates or finds corresponding controlling instruction according to the recognizing results, and executes the controlling instruction, or the controlled equipment responds to the received recognizing results, such as, the controlled equipment reports back the current state information of itself; the intelligent controlling system can also generate corresponding controlling instruction after acquiring the scene recognizing result and the action recognizing result, and send the controlling instruction to the controlled equipment, the controlled equipment executes corresponding operations according tot the controlling instruction.

The present disclosure controls the corresponding controlled device through recognizing the current scene and user's action, for achieving intelligently controlling the controlled equipment, the user does not need to do special action or gesture, also does not need to take a mobile terminal used for sending instruction, it is much more intelligent and convenient to control the controlled equipment.

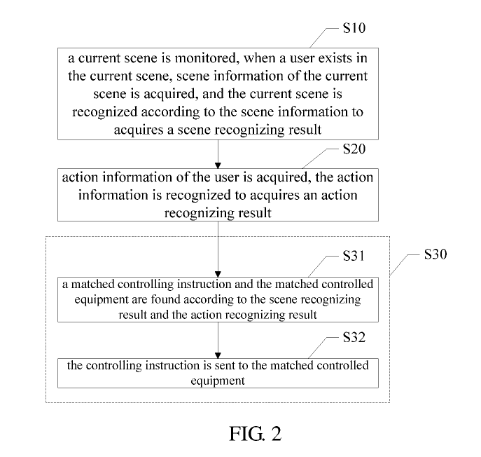

Referring to FIG. 2, FIG. 2 is a flow diagram of a method for intelligently controlling a controlled equipment provided by a second exemplary embodiment of the present disclosure. The second exemplary embodiment includes all steps in the first exemplary embodiment shown in FIG. 1, and step S30 includes:

Step S31, finding a matched controlling instruction and the matched controlled equipment according to the scene recognizing result and the action recognizing result;

The exemplary embodiment prestores the scene recognizing result, the action recognizing result and the controlling instruction in an instruction set database, the intelligent controlling system acquires the scene recognizing result and the action recognizing result according to the recognizing, and searches matched instruction and matched controlled equipment from the preset instruction set database, the same action can have different meaning in different scenes, and correspond to different matched instructions, so that the generated instruction is much more accuracy. Such as, a recognizing result “sitting room +sit down” is related with the instruction “turning on the droplight in the sitting room”, a recognizing result “dinning room +sit down” is related with the instruction “turning on the light in the dinning room”. In addition, a pair of the scene recognizing result and the action recognizing result can correspond to one controlling instruction or a plurality of controlling instructions, such as, the recognizing result “sitting room +sit down” is related with the instruction “turning on the droplight”, the instruction “opening the television A”, the instruction “opening the cabinet air conditioner”.

Step S32, sending the controlling instruction to the matched controlled equipment.

After the matched controlling instruction and the controlled equipment, the intelligent controlling system sends the controlling instructions to the corresponding controlled equipment respectively, for controlling the controlled equipment to operate correspondingly. Such as, the instruction “turning on the droplight” is sent to the droplight in the sitting room, the droplight in the sitting room is controlled to turn on; the instruction “opening the television A” is sent to the television A , the television A is controlled to work; the instruction “opening the cabinet air conditioner” is sent to the cabinet air conditioner, the cabinet air conditioner is controlled to work. The controlling instructions can be sent through WIFI, infrared, bluetooth, Z-Wave, ZigBee, and so on.

The present disclosure searches matched controlling instruction and controlled equipment through recognizing the current scene and user's action, the controlled equipment executes under the control of the searched controlling instruction, the intelligent controlling of the controlled equipment is realized, the generated controlling instruction is much more accuracy.

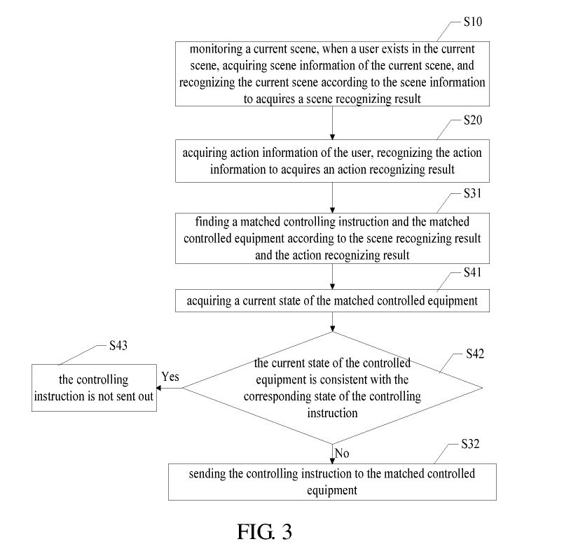

Referring to FIG. 3, FIG. 3 is a flow diagram of a method for intelligently controlling a controlled equipment provided by a third exemplary embodiment of the present disclosure. The third exemplary embodiment includes all steps in the second exemplary embodiment shown in FIG. 2, before step S32, the method for intelligently controlling the controlled equipment also includes:

Step S41, acquiring the current state of the matched controlled equipment;

Step S42, judging whether the current state of the matched controlled equipment is consistent with a corresponding state of the controlling instruction; if yes, go to step S43; if no, go to step S32;

Step S43, the controlling instruction is not sent out.

In the exemplary embodiment, in order to avoid sending illegal instruction to the controlled equipment, and improve the intelligent controlling efficiency, the intelligent controlling system adjusts a current operating state of the controlled equipment before sending the controlling instruction to the controlled equipment. The intelligent controlling system can acquire the current state of the controlled equipment through WIFI, infrared, bluetooth, Z-Wave, ZigBee, and so on, or the controlled equipment automatically sends the current state of the controlled equipment to the intelligent controlling system after executing each operating instruction through WIFI, infrared, bluetooth, Z-Wave, ZigBee, and so on. The intelligent controlling system can establish a state recording sheet according to an arriving time of the state for searching easily, can also only record the last state information for saving information storing space. When the current state of the controlled equipment is consistent with the corresponding state of the controlling instruction, such as the current state of the television A is a shut down state, while the controlling instruction is “shutting down the television A”, and the corresponding state of the controlling instruction is consistent with the current state of the television A, if the intelligent controlling system continues to send the controlling instruction “shutting down the television A” to the television A, the television A would not response to the instruction, so, in order to save the processing procedures of the intelligent controlling system, the intelligent controlling system does not need to send the controlling instruction, it is benefit for improving the intelligent controlling efficiency, and avoid a waste of resource.

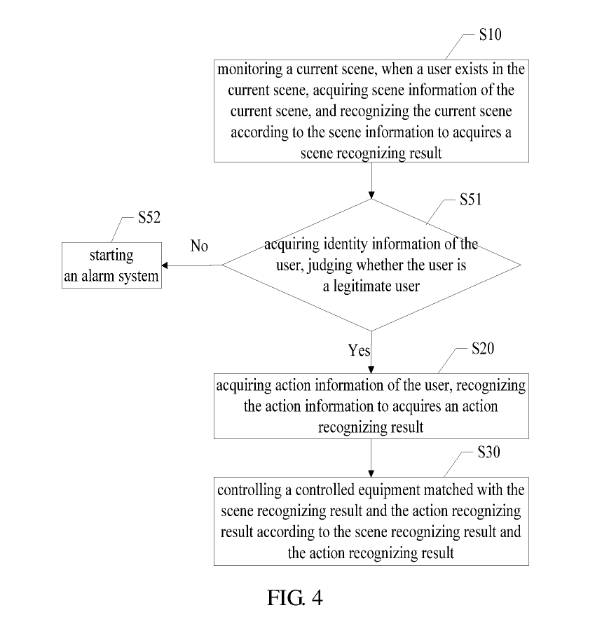

Referring to FIG. 4, FIG. 4 is a flow diagram of a method for intelligently controlling a controlled equipment provided by a fourth exemplary embodiment of the present disclosure. The fourth exemplary embodiment includes all steps in the first exemplary embodiment shown in FIG. 1, before the step S20, the method for intelligently controlling the controlled equipment also includes:

Step S51, acquiring identity information of the user, judging whether the user is a legitimate user; if yes, going to step S20; if no, going to step S52;

Step S52, starting an alarm system.

Before the exemplary embodiment recognizes the action of the user, the identity of the user should be recognized for judging whether the user is the legitimate user. If the current user is not a preset legitimate user, an illegal user may intrude into the current scene. Such as, in the office environment, when the legitimate user goes to the office and sits down on a seat, the intelligent controlling system controls the computer in the office to work, however, if the illegal user intrudes into the office, in order to avoid the illegal user stealing data in the computer, the intelligent controlling system recognizes the identity of the user, and judges that the current user is illegal user, and starts the alarm system, it is benefit to improve the safety of the intelligent controlling. Identity recognizing method can be inputting user password or fingerprint information, and so on, before entering into the environment. Such as, before entering into the room or the office, code or fingerprint inputting device can be installed at the door of the room or the office, the legitimate user can input correct code or fingerprint information, illegal user cannot provide correct code or fingerprint information, or does not input code and fingerprint, code or fingerprint inputting device will send received information to the intelligent controlling system for recognizing, to ensure the safety of the intelligent controlling and the environment.

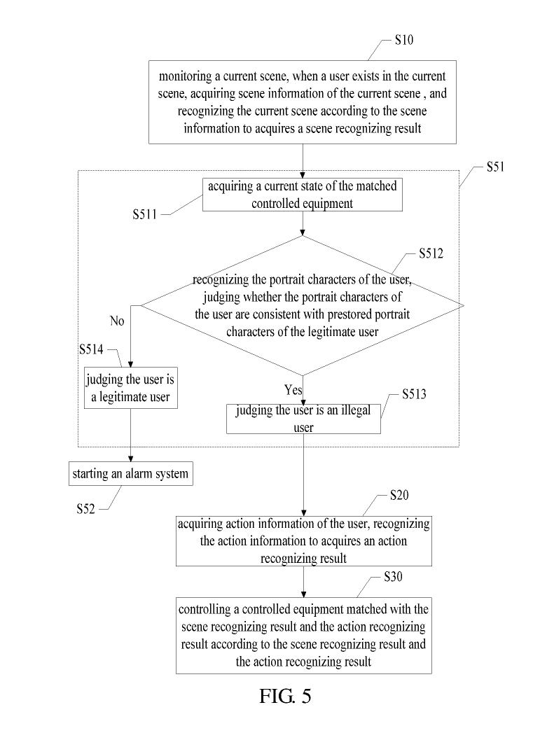

Referring to FIG. 5, FIG. 5 is a flow diagram of a method for intelligently controlling a controlled equipment provided by a fifth exemplary embodiment of the present disclosure. The fifth exemplary embodiment includes all steps in the fourth exemplary embodiment shown in FIG. 4, and the step S51 includes:

Step S511, extracting portrait characters of the user from the scene information;

Step S512, recognizing the portrait characters of the user, judging whether the portrait characters of the user are consistent with prestored portrait characters of the legitimate user; of yes, going to step S513; if no, going to step S514;

Step S513, judging the user as the legitimate user, go to step S20;

Step S514, judging the user as an illegal user, go to step S52.

The exemplary embodiment adopts the image recognizing method to recognize the identity of the user. After the user enters into the scene, the scene information acquired by the camera includes portrait of the user, the intelligent controlling system can extract portrait characters of the user are extracted from the scene information, the portrait characters includes facial characters, body characters, iris characters, and so on, can also includes walking type, sitting posture, Verbal habits and so on, the intelligent controlling system can recognize user's identity through one character or a plurality of the characters, when the acquired character is consistent with legitimate user's character, the identity authentication is effective, corresponding intelligent controlling operation is executes, when the acquired character is not consistent with legitimate user's character, the identity authentication is not effective, the alarm system starts, it is benefit to improve the safety of the intelligent controlling.

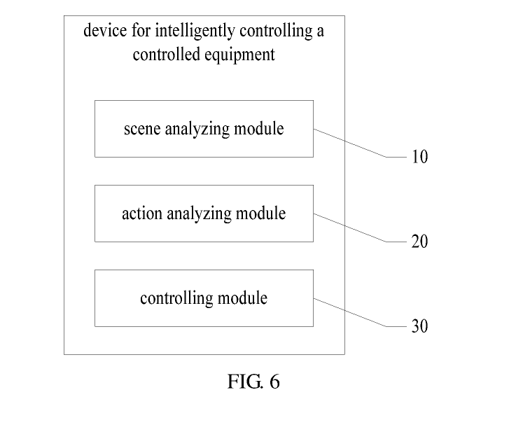

Referring to FIG. 6, FIG. 6 is a module diagram of a device for intelligently controlling a controlled equipment provided by a first exemplary embodiment of the present disclosure. The device for intelligently controlling the controlled equipment provided by the exemplary embodiment includes:

a scene analyzing module 10, the scene analyzing module 10 is used for monitoring a current scene, when a user exists in the current scene, and the scene analyzing module 10 acquires scene information of the current scene, and the current scene is recognized according to the scene information, a scene recognizing result is acquired;

an action analyzing module 20, the action analyzing module 20 is used for acquiring action information of the user, the action information is recognized, an action recognizing result is acquired; and

a controlling module 30, the controlling module 30 is used for controlling the controlled equipment matched with the scene recognizing result and the action recognizing result according to the scene recognizing result and the action recognizing result.

The exemplary embodiment is mainly used in an intelligent system, and is applied in environment, such as home, office, security, and so on, for intelligently controlling equipment, such as household equipment, office equipment, security system, and so on. Functions, such as acquiring, analyzing, recognizing, matching data, and sending instruction, can be finished by the intelligent controlling system. Taking the room environment for an example, image or video acquiring equipment (such as a camera) is installed at each scene of the room, such as a door, a sitting room, a dining room, a bedroom and so on, each scene is monitored by the camera, when the user enters into one scene, such as the user works to the sitting room, when a portrait is monitored in the current scene through the camera installed in the sitting room, the camera acquires the scene information of the current scene, such as the camera takes images of the current scene, or records videos of the current scene. The camera transmits the acquired scene information to the intelligent system, the intelligent system recognizes according to the scene information, such as image processing, visual identifying and so on, for acquiring the scene recognizing result, and the current scene is recognized as the sitting room. In addition, the recognized scene can also be a much more detail scene, such as the user works to the sitting room and go to a sofa nearby, and the acquired scene recognizing result can be “sitting room+sofa.

The scene information of the current scene is acquired, simultaneously the camera also shoots user's action video, which can be used as the action information of the user. The camera transmits user's action information to the intelligent controlling system, the intelligent controlling system recognizes user's action information through the technologies of image processing, visual recognizing, mode recognizing and so on, for acquiring user's detail action, such as, the user sits down the sofa in the sitting room, and the action recognizing result “sitting down” is acquired.

The intelligent controlling system associates the information of the current scene with information of the controlled equipment installed or placed in the scene, and stores the associated information of the current scene and the information of the controlled equipment in advance, that is, what controlled equipment are installed or placed in the current scene, so that the corresponding controlled equipment can be found out and be intelligently controlled after the current scene is recognized. Such as the sitting room has a suspended ceiling, a television A, a cabinet air conditioner, and so on, the bedroom has a table lamp, a television B, a hanging type air conditioner, and so on. After acquiring the scene recognizing result and the action recognizing result, the intelligent controlling system can directly send the recognizing results to the matched controlled equipment, as the controlled equipment generates or finds corresponding controlling instruction according to the recognizing results, and executes the controlling instruction, or the controlled equipment responds to the received recognizing results, such as, the controlled equipment reports back the current state information of itself; the intelligent controlling system can also generate corresponding controlling instruction after acquiring the scene recognizing result and the action recognizing result, and send the controlling instruction to the controlled equipment, the controlled equipment executes corresponding operations according tot the controlling instruction.

The present disclosure controls the corresponding controlled device through recognizing the current scene and user's action, for achieving intelligently controlling the controlled equipment, the user does not need to do special action or gesture, also does not need to take a mobile terminal used for sending instruction, it is much more intelligent and convenient to control the controlled equipment.

Furthermore, the controlling module 30 is also used for:

finding a matched controlling instruction and the matched controlled equipment according to the scene recognizing result and the action recognizing result;

sending the controlling instruction to the matched controlled equipment.

The exemplary embodiment prestores the scene recognizing result, the action recognizing result and the controlling instruction in an instruction set database, the intelligent controlling system acquires the scene recognizing result and the action recognizing result according to the recognizing, and searches matched instruction and matched controlled equipment from the preset instruction set database, the same action can have different meaning in different scenes, and correspond to different matched instructions, so that the generated instruction is much more accuracy. Such as, a recognizing result “sitting room+sit down” is related with the instruction “turning on the droplight in the sitting room”, a recognizing result “dinning room +sit down” is related with the instruction “turning on the light in the dinning room”. In addition, a pair of the scene recognizing result and the action recognizing result can correspond to one controlling instruction or a plurality of controlling instructions, such as, the recognizing result “sitting room+sit down” is related with the instruction “turning on the droplight”, the instruction “opening the television A”, the instruction “opening the cabinet air conditioner”.

After the matched controlling instruction and the controlled equipment, the intelligent controlling system sends the controlling instructions to the corresponding controlled equipment respectively, for controlling the controlled equipment to operate correspondingly. Such as, the instruction “turning on the droplight” is sent to the droplight in the sitting room, the droplight in the sitting room is controlled to turn on; the instruction “opening the television A” is sent to the television A , the television A is controlled to work; the instruction “opening the cabinet air conditioner” is sent to the cabinet air conditioner, the cabinet air conditioner is controlled to work. The controlling instructions can be sent through WIFI, infrared, bluetooth, Z-Wave, ZigBee, and so on.

The present disclosure searches matched controlling instruction and controlled equipment through recognizing the current scene and user's action, the controlled equipment executes under the control of the searched controlling instruction, the intelligent controlling of the controlled equipment is realized, the generated controlling instruction is much more accuracy.

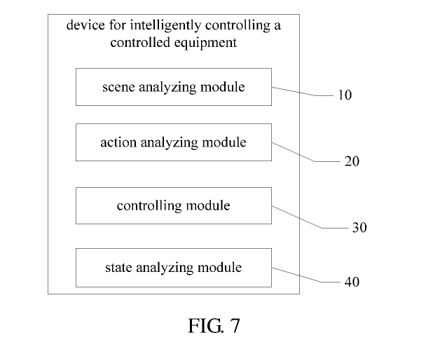

Referring to FIG. 7, FIG. 7 is a module diagram of a device for intelligently controlling a controlled equipment provided by a second exemplary embodiment of the present disclosure. The second exemplary embodiment includes all the modules in the first exemplary embodiment shown in FIG. 6, and the second exemplary embodiment further includes a state analyzing module 40.

The state analyzing module 40 is used for acquiring a current state of the matched controlled equipment; judging whether the current state of the matched controlled equipment is consistent with a corresponding state of the controlling instruction;

The controlling module 30 does not send the controlling instruction when the current state is consistent with the corresponding state of the controlling instruction, when the current state is not consistent with the corresponding state of the controlling instruction, the controlling module 30 is used for sending the controlling instruction to the matched controlled equipment.

In the exemplary embodiment, in order to avoid sending illegal instruction to the controlled equipment, and improve the intelligent controlling efficiency, the intelligent controlling system adjusts a current operating state of the controlled equipment before sending the controlling instruction to the controlled equipment. The intelligent controlling system can acquire the current state of the controlled equipment through WIFI, infrared, bluetooth, Z-Wave, ZigBee, and so on, or the controlled equipment automatically sends the current state of the controlled equipment to the intelligent controlling system after executing each operating instruction through WIFI, infrared, bluetooth, Z-Wave, ZigBee, and so on. The intelligent controlling system can establish a state recording sheet according to an arriving time of the state for searching easily, can also only record the last state information for saving information storing space. When the current state of the controlled equipment is consistent with the corresponding state of the controlling instruction, such as the current state of the television A is a shut down state, while the controlling instruction is “shutting down the television A”, and the corresponding state of the controlling instruction is consistent with the current state of the television A, if the intelligent controlling system continues to send the controlling instruction “shutting down the television A” to the television A, the television A would not response to the instruction, so, in order to save the processing procedures of the intelligent controlling system, the intelligent controlling system does not need to send the controlling instruction, it is benefit for improving the intelligent controlling efficiency, and avoid a waste of resource.

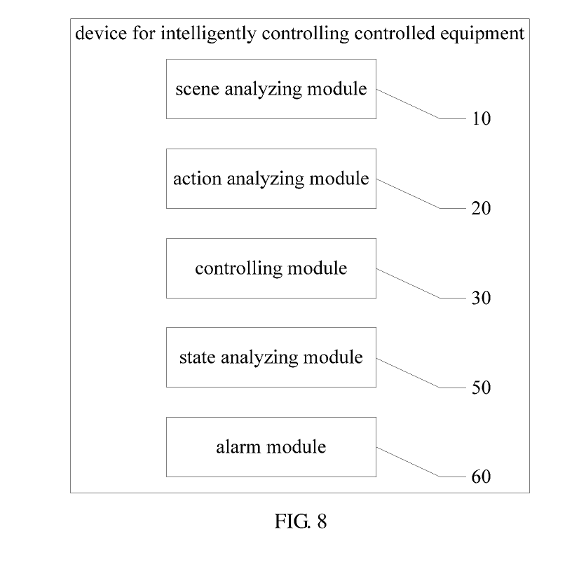

Referring to FIG. 8, FIG. 8 is a module diagram of a device for intelligently controlling a controlled equipment provided by a third exemplary embodiment of the present disclosure. The third exemplary embodiment includes all the modules in the first exemplary embodiment shown in FIG. 6, and the third exemplary embodiment further includes an identity recognizing module 50 and an alarming module 60.

The identity recognizing module 50 is used for acquiring identity information of the user, whether the user is a legitimate user is judged;

When the user is the legitimate user, the action analyzing module 20 is also used for acquiring the action information of the user;

The alarming module 60 is used for starting alarm system when the user is not the legitimate user.

Before the exemplary embodiment recognizes the action of the user, the identity of the user should be recognized for judging whether the user is the legitimate user. If the current user is not a preset legitimate user, an illegal user may intrude into the current scene. Such as, in the office environment, when the legitimate user goes to the office and sits down on a seat, the intelligent controlling system controls the computer in the office to work, however, if the illegal user intrudes into the office, in order to avoid the illegal user stealing data in the computer, the intelligent controlling system recognizes the identity of the user, and judges that the current user is illegal user, and starts the alarm system, it is benefit to improve the safety of the intelligent controlling. Identity recognizing method can be inputting user password or fingerprint information, and so on, before entering into the environment. Such as, before entering into the room or the office, code or fingerprint inputting device can be installed at the door of the room or the office, the legitimate user can input correct code or fingerprint information, illegal user cannot provide correct code or fingerprint information, or does not input code and fingerprint, code or fingerprint inputting device will send received information to the intelligent controlling system for recognizing, to ensure the safety of the intelligent controlling and the environment.

Furthermore, the identity recognizing module 50 is also used for:

extracting portrait characters of the user from the scene information;

recognizing the portrait characters of the user, whether the portrait characters of the user are consistent with prestored portrait characters of the legitimate user is judged;

if yes, the user is judged as the legitimate user;

if not, the user is judged as an illegal user.

The exemplary embodiment adopts the image recognizing method to recognize the identity of the user. After the user enters into the scene, the scene information acquired by the camera includes portrait of the user, the intelligent controlling system can extract portrait characters of the user are extracted from the scene information, the portrait characters includes facial characters, body characters, iris characters, and so on, can also includes walking type, sitting posture, Verbal habits and so on, the intelligent controlling system can recognize user's identity through one character or a plurality of the characters, when the acquired character is consistent with legitimate user's character, the identity authentication is effective, corresponding intelligent controlling operation is executes, when the acquired character is not consistent with legitimate user's character, the identity authentication is not effective, the alarm system starts, it is benefit to improve the safety of the intelligent controlling.

The embodiments above are preferably embodiments of the present disclosure, and the present disclosure is not limited to such embodiments, equivalent structure conversion based on the specification and the drawing of the present disclosure, or directly or indirectly used in other related technical field, both similarly within the protection scope of the present disclosure.

What is claimed is:

1. A method for intelligently controlling a controlled equipment, comprising the following steps:
monitoring a current scene, when a user existing in the current scene, acquiring scene information of the current scene, recognizing the current scene according to the scene information, acquiring a scene recognizing result;
acquiring action information of the user, recognizing the action information, acquiring an action recognizing result; and
controlling a controlled equipment matched with the scene recognizing result and the action recognizing result according to the scene recognizing result and the action recognizing result.

2. The method for intelligently controlling a controlled equipment according to claim 1, wherein controlling a controlled equipment matched with the scene recognizing result and the action recognizing result according to the scene recognizing result and the action recognizing result comprises:
finding a matched controlling instruction and the matched controlled equipment according to the scene recognizing result and the action recognizing result;
sending the controlling instruction to the matched controlled equipment.

3. The method for intelligently controlling a controlled equipment according to claim 2, wherein before sending the controlling instruction to the matched controlled equipment, the method for intelligently controlling the controlled equipment further comprises:
acquiring a current state of the matched controlled equipment;
judging whether the current state of the matched controlled equipment is consistent with a corresponding state of the controlling instruction;
when the current state is consistent with the corresponding state of the controlling instruction, making the controlling instruction to be not sent out;
when the current state is not consistent with the corresponding state of the controlling instruction, sending the controlling instruction to the matched controlled equipment.

4. The method for intelligently controlling a controlled equipment according to claim 3, wherein before acquiring action information of the user, the method for intelligently controlling the controlled equipment further comprises:
acquiring identity information of the user, judging whether the user is a legitimate user;
when the user is the legitimate user, acquiring the action information of the user;
when the user is not the legitimate user, starting an alarm system.

5. The method for intelligently controlling a controlled equipment according to claim 4, wherein acquiring the identity information of the user, judging whether the user is the legitimate user comprises:
extracting portrait characters of the user from the scene information;
recognizing the portrait characters of the user, judging whether the portrait characters of the user are consistent with prestored portrait characters of the legitimate user;
if yes, judging the user as the legitimate user;
if not, judging the user as an illegal user.

6. The method for intelligently controlling a controlled equipment according to claim 2, wherein before acquiring the identity information of the user, judging whether the user is the legitimate user, the method for intelligently controlling a controlled equipment further comprises:
acquiring identity information of the user, judging whether the user is a legitimate user;
when the user is the legitimate user, acquiring the action information of the user;
when the user is not the legitimate user, starting an alarm system.

7. The method for intelligently controlling a controlled equipment according to claim 6, wherein acquiring the identify of the user, judging whether the user is the legitimate user comprises:
extracting portrait characters of the user from the scene information;
recognizing the portrait characters of the user, judging whether the portrait characters of the user are consistent with prestored portrait characters of the legitimate user;
if yes, judging the user as the legitimate user;
if not, judging the user as an illegal user.

8. The method for intelligently controlling a controlled equipment according to claim 1, wherein before acquiring the identity information of the user, judging whether the user is the legitimate user, the method for intelligently controlling a controlled equipment further comprises:
acquiring identity information of the user, judging whether the user is a legitimate user;
when the user is the legitimate user, acquiring the action information of the user;
when the user is not the legitimate user, starting an alarm system.

9. The method for intelligently controlling a controlled equipment according to claim 8, wherein acquiring the identify of the user, judging whether the user is the legitimate user comprises:
extracting portrait characters of the user from the scene information;
recognizing the portrait characters of the user, judging whether the portrait characters of the user are consistent with prestored portrait characters of the legitimate user;
if yes, judging the user as the legitimate user;
if not, judging the user as an illegal user.

10. A device for intelligently controlling a controlled equipment, comprising:
a scene analyzing module, the scene analyzing module being used for monitoring a current scene, when a user existing in the current scene, the scene analyzing module acquiring scene information of the current scene, and recognizing the current scene according to the scene information, acquiring a scene recognizing result;
an action analyzing module, the action analyzing module being used for acquiring action information of the user, recognizing the action information, acquiring an action recognizing result; and
a controlling module, the controlling module being used for controlling a controlled equipment matched with the scene recognizing result and the action recognizing result according to the scene recognizing result and the action recognizing result.

11. The device for intelligently controlling a controlled equipment according to claim 10, wherein the controlling module is also used for:
finding a matched controlling instruction and the matched controlled equipment according to the scene recognizing result and the action recognizing result;
sending the controlling instruction to the matched controlled equipment.

12. The device for intelligently controlling a controlled equipment according to claim 11, wherein the device for intelligently controlling the controlled equipment further comprises a state analyzing module, which is used for acquiring a current state of the matched controlled equipment; judging whether the current state of the matched controlled equipment is consistent with a corresponding state of the controlling instruction;
the controlling module does not send the controlling instruction when the current state is consistent with the corresponding state of the controlling instruction, when the current state is not consistent with the corresponding state of the controlling instruction, the controlling module is used for sending the controlling instruction to the matched controlled equipment.

13. The device for intelligently controlling a controlled equipment according to claim 12, wherein the device for intelligently controlling the controlled equipment further comprises an identity recognizing module and an alarming module;
the identity recognizing module is used for acquiring identity information of the user, whether the user is a legitimate user is judged;
the action analyzing module is also used for acquiring the action information of the user when the user is the legitimate user;
the alarming module is used for starting alarm system when the user is not the legitimate user.

14. The device for intelligently controlling a controlled equipment according to claim 13, wherein the identity recognizing module is also used for:
extracting portrait characters of the user from the scene information;
recognizing the portrait characters of the user, whether the portrait characters of the user are consistent with prestored portrait characters of the legitimate user is judged;
if yes, the user is judged as the legitimate user;
if not, the user is judged as an illegal user.

15. The device for intelligently controlling a controlled equipment according to claim 11, wherein the device for intelligently controlling a controlled equipment further comprises an identity recognizing module and an alarming module;
the identity recognizing module is used for acquiring identity information of the user, whether the user is a legitimate user is judged;
the action analyzing module is also used for acquiring the action information of the user, when the user is the legitimate user;
the alarming module is used for starting alarm system when the user is not the legitimate user.

16. The device for intelligently controlling a controlled equipment according to claim 15, wherein the identity recognizing module is also used for:
extracting portrait characters of the user from the scene information;
recognizing the portrait characters of the user, whether the portrait characters of the user are consistent with prestored portrait characters of the legitimate user is judged;
if yes, the user is judged as the legitimate user;
if not, the user is judged as an illegal user.

17. The device for intelligently controlling a controlled equipment according to claim 10, wherein the device for intelligently controlling a controlled equipment further comprises an identity recognizing module and an alarming module;
the identity recognizing module is used for acquiring identity information of the user, whether the user is a legitimate user is judged;
the action analyzing module is also used for acquiring the action information of the user, when the user is the legitimate user;
the alarming module is used for starting alarm system when the user is not the legitimate user.

18. The device for intelligently controlling a controlled equipment according to claim 17, wherein the identity recognizing module is also used for:
extracting portrait characters of the user from the scene information;
recognizing the portrait characters of the user, whether the portrait characters of the user are consistent with prestored portrait characters of the legitimate user is judged;
if yes, the user is judged as the legitimate user;
if not, the user is judged as an illegal user.
